(19) United States
(12) Patent Application Publication
(10) Pub. No.: US 2020/0408878 A1
(43) Pub. Date: Dec. 31, 2020

(54) A RADAR TRANSCEIVER WITH REDUCED FALSE ALARM RATE

(71) Applicant: QAMCOM TECHNOLOGY HOLDING AB, Göteborg (SE)

(72) Inventors: Zijun LIANG, Göteborg (SE); Christer ANDERSSON, Göteborg (SE); Gary SMITH JONFORSEN, Askim (SE)

(21) Appl. No.: 16/975,822

(22) PCT Filed: Feb. 25, 2019
(86) PCT No.: PCT/EP2019/054518

§ 371 Date: Aug. 26, 2020

(30) Foreign Application Priority Data
Feb. 27, 2018 (SE) 1830060-8

(51) Int. Cl. G01S 7/292; G01S 7/35; G01S 13/30; G01S 7/02

(52) U.S. Cl. CPC G01S 7/2927; G01S 7/023; G01S 13/30; G01S 7/354

(57) ABSTRACT

A method for operating a radar transceiver to reduce a false alarm rate, the method including transmitting by at least one transmitter antenna, one or more frames at a duty cycle, each frame including N segments, each segment including M signal components, wherein the N segments are consecutively transmitted within the frame, receiving, by K receiver antennas, a response signal from a region of interest, ROI, detecting, for each segment, one or more target object reflections in the response signal, assigning, for each segment, a segment weight value to each of the one or more detected target object reflections, wherein a segment weight value corresponds to a likelihood of the associated target object reflection being associated with a false alarm, and filtering the target object reflections over the N segments based on the segment weight values.

### TECHNICAL FIELD

The present disclosure relates to radar transceivers and methods suitable for monitoring transportation infrastructure such as railway crossings, and for vehicular applications in general.

### BACKGROUND

Radio detection and ranging (RADAR) systems are sensor systems arranged to produce output comprising a series of reflection points as measured by radar receiver sensors. A radar transmitter and receiver together implement a radar transceiver. Reflection points can be treated as separate detections or grouped if they relate to the same object. Reflection points or groups of reflection points observed over time can be used to track the motion of an object over time. Radar systems may be used to detect objects in a vicinity of a vehicle by means of radar signal reflections. Radar systems may also be used to monitor a region of interest (ROI) in order to detect objects entering and leaving the region.

A false alarm is when the radar transceiver outputs a reflection point that does not relate to a relevant target, or to a non-existing target. Due to, e.g., noise and movement of non-relevant nearby objects (e.g. tree branches), there is always a finite probability that a false alarm will occur. False alarms can be mistaken for real objects or cause issues with the tracking of objects. For example, if a false alarm occurs near a real object it may be included in the track of the object, which may then affect estimation of object direction or position negatively.

U.S. Pat. No. 7,577,218 B2 describes an approach for false alarm reduction that identifies multiple peaks in a signal and requires the number of peaks to exceed a threshold.

U.S. Pat. No. 7,843,375 B1 describes an approach for lowering the false alarm rate of airborne radar transceivers using an add-on receiver.

Still, there is a need for improved radar systems associated with a reduced false alarm rate.

### SUMMARY

It is an object of the present disclosure to provide a radar transceiver, systems, methods, and computer programs which enable radar operation with reduced false alarm rate.

This object is achieved by a method for operating a radar transceiver to reduce a false alarm rate. The method comprises transmitting, by at least one transmitter antenna, one or more frames at a duty cycle. Each frame comprises N segments. Each segment comprises M signal components, where a signal component may for example be a repeated pattern of frequency modulation. The N segments are consecutively transmitted within the frame. The method also comprises receiving, by K receiver antennas, a response signal from a region of interest, ROI, and detecting, for each segment, one or more target object reflections in the response signal. The method comprises assigning, for each segment, a segment weight value to each of the one or more detected target object reflections, wherein a segment weight value corresponds to a likelihood of the associated target object reflection being associated with a false alarm, and filtering the target object reflections over the N segments based on the segment weight values.

By transmitting segments back-to-back in a frame and assigning respective segment weight values to detections made in each segment, true target detections are distinguished from false alarms which do not appear in more than one segment and/or which are assigned a lower weight value. Consequently, false alarms can be filtered out by means of the filtering operation based on the segment weight values, thereby significantly reducing the false alarm rate of the radio detection and ranging operation.

According to aspects, the transmitting comprises transmitting the N segments at different center frequencies in a transmission frequency band. This way frequency dependent false alarms can be efficiently suppressed. A false alarm originating from, e.g., transmissions by another radar transmitter, is not likely to follow the same different center frequencies, and therefore will not appear in more than one consecutive segment. Such false alarms will therefore be filtered out in the filtering operation based on the per segment assigned segment weight values.

According to aspects, the transmitting comprises transmitting a parking signal at a parking center frequency between transmission of the one or more frames. Advantageously, the transmission of the parking signal reduces problems with transient behavior of the hardware during start-up.

According to aspects, the signal components are chirp signal components constituting a frequency sweep between first and second endpoint frequency values.

According to aspects, the detecting comprises determining a range Fast Fourier Transform, FFT, for each of the M signal components, and determining S32 Doppler FFTs based on the M signal components.

Advantageously, the chirp signal components facilitate detection by Fourier transform processing for determining range and velocity in a stable manner.

According to aspects, the detecting comprises determining a background signal energy level prior to the detecting, and subtracting the background signal energy level from the range FFTs and from the Doppler FFTs. This way objects entering a region of interest can be separated from objects which are stationary in the region, since the energy reflected by stationary objects are compensated for prior to the detecting. This way any background motion is also accounted for prior to the detecting.

According to aspects, the segment weight value is determined based on a difference measured from the target object detection value to a corresponding value of the background signal energy level. Consequently, a detection value associated with a large difference compared to background signal levels is assigned a higher weight value compared to a detection value associated with smaller difference. This way, contributions from background signal energy and contributions from relevant target objects are separated by means of the weight values. A strong reflection is a reflection with energy high above the background level. Thus, the absolute energy in a strong reflection may actually be smaller than the absolute energy in a weaker reflection depending on corresponding background signal energy levels.

According to aspects, the detecting comprises determining an angle of arrival value for each range-Doppler combination, based on corresponding target object detection values from each of the K receiver antennas compared to one or more angle of arrival calibration vectors. The determining of angle of arrival based on a-priori stored calibration vectors allow for variation in the receiver array deployment geometry and provides for a more robust detection mechanism. The calibration vectors may, e.g., comprise phase values for the respective receiver antennas for different angle of arrivals in both bearing and azimuth.

According to aspects, the segment weight value is determined based on a difference between one or more angle of arrival calibration vectors and corresponding target object detection values from each of the K receiver antennas. This way, target object detection values which do not correspond to a meaningful angle of arrival can be given a lower weight value compared to object detection values which correspond to meaningful angle of arrivals. For instance, some phase vector values do not correspond to any angle of arrival, or to an angle of arrival representing, e.g., a direction up into air, or a direction which terminates into ground prior to an associated range value.

According to aspects, the filtering comprises comparing target object reflections detected in a plurality of segments. By comparing target object reflections between segments, false alarms can be separated from relevant target object detections. This is because false alarms often occur in a single segment, and do not repeat for successive consecutive segments. Thus, e.g., by requiring a target object detection to be present in a plurality of segments, detection robustness is obtained. The comparing target of object reflections between segments is especially effective when used together with different segment center frequencies, but can also be used with a fixed segment center frequency.

According to some aspects, the different frequency bands used for the different segments are arranged overlapping. This conserves bandwidth during operation and confines the overall radar transmission to a more narrow frequency band despite the frequency diversity that is introduced by the different center frequencies.

According to aspects, the filtering comprises calculating a difference in range and angle of arrival of target object detections from different segments. By calculating such differences, a true target object detection can be separated from false alarms in the filtering operation. This is because a true target is more likely to exhibit a relatively small variance in detection values over the different segments, while a false alarm due to, e.g., noise, is likely to be more random in nature.

According to aspects, the filtering is based on how many target object detections from other segments that fall within a radius R meters of a given target object detection. A true target object reflection is likely associated with a cluster of scattering points, which will give rise to a plurality of target object detections within a radius R. A false alarm on the other hand, is more likely an isolated event in terms of range.

According to aspects, the value of the radius R depends on the range to the target object detection considered. Thresholds for segment weight value and number of adjacent target object detections may be lower at higher range. The main benefit of range-dependent thresholds is reducing the risk that target object detections corresponding to targets far away in range be mistaken for false alarms, considering that a given target may cause fewer target object detections with lower associated segment weight value if it is placed further away from the transceiver.

According to aspects, the filtering comprises tracking one or more target objects over consecutive frames. Tracking may provide a further means to suppress reflections corresponding to false alarms, which false alarm reflections are likely to exhibit a more erratic behavior over time compared to reflections due to target objects.

There are also disclosed herein computer programs, computer program products, signal processing devices, and radar transceivers associated with the same functions and advantages discussed above.

### BRIEF DESCRIPTION OF THE DRAWINGS

The present disclosure will now be described more in detail with reference to the appended drawings, where:

FIG. 1 is a block diagram illustrating a radar transceiver;

FIG. 2 schematically illustrates a radar transmission format;

FIG. 3 is a flowchart illustrating methods according to the present disclosure;

FIG. 4 is a block diagram illustrating a radar control unit.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

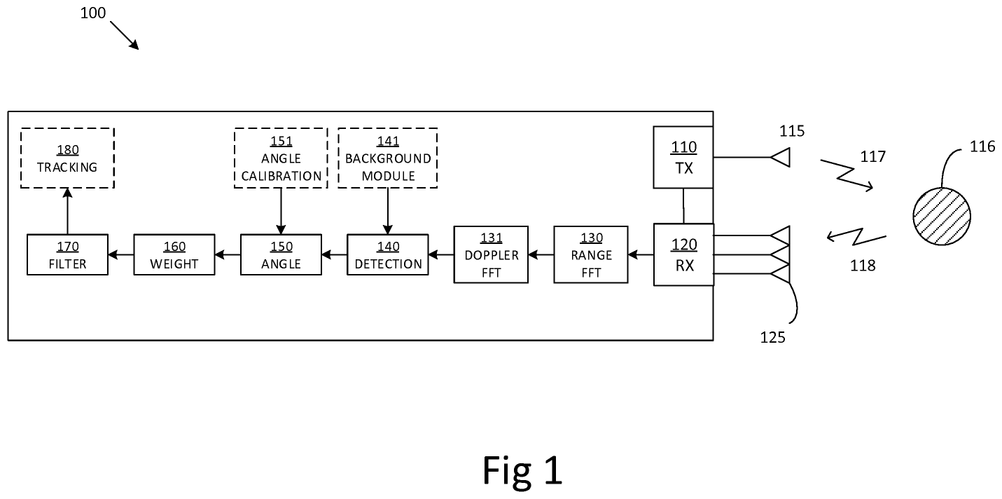

FIG. 1 illustrates a radar transceiver 100 arranged for transmission of radar signals 117. The transmission occurs from at least one transmission element 115, controlled by a TX module 110.

The TX module is known and will not be discussed in detail here. The transmitted radio signal 117 is scattered against one or more targets 116 and the reflected signal 118 is received by K receiver elements 125, where K is larger than one. According to the example in FIG. 1, the received signal is sent to an RX module 120, where the received signal is down-converted in frequency to an intermediate frequency signal or to a baseband signal. A range fast Fourier transform (FFT) 130 and a Doppler FFT 131 are then obtained from the down-converted signal. Methods for determining of range and Doppler FFTs, in general, are known and will not be discussed in more detail here.

According to an alternative, the range and Doppler FFTs are determined directly from the received signal at radio frequency.

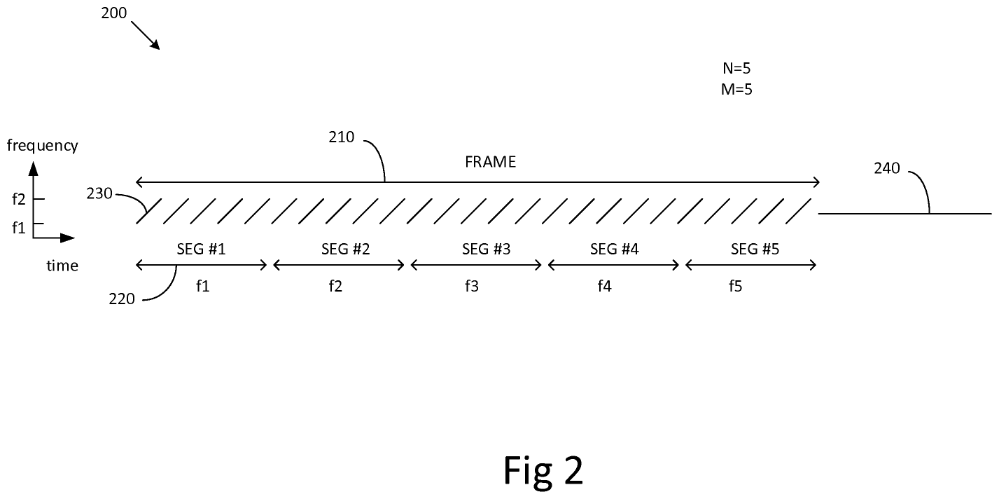

FIG. 2 shows an example of a transmission format 200. A frame 210 comprises N segments 220, each segment comprising M signal components 230. Following the transmission of the entire frame, a parking signal 240 is transmitted until the start of the next frame. As will be discussed below, division of the frame into segments enables reflection points to be identified for each segment rather than once for the whole frame.

According to an example, the transmitted radar signals 117 may be formatted as chirp signals, which chirp signals are periodically swept in frequency according to a saw-tooth pattern. FIG. 2 illustrates a transmission format where the signal components 230 are chirp signal components starting at a frequency f1 and linearly increasing until frequency f2. The chirp transmissions repeat during a transmission frame.

Referring back again to FIG. 1, and assuming that the transmitted radar signal 117 comprises chirp signals, the transmitted chirp signals are down-converted using a replica of the chirp signals, often denoted as reference signal. In case there is a reflection from a target 116, this reflection will have a phase shift relative to the reference signal, and the phase shift will be a function of the range from the transmitting 115 and receiving 125 elements to the target 116. Consequently, the range to the target 116 can be determined from the frequency of the intermediate or baseband signal. If there is such a frequency component in the down-converted signal, then it will be visible in the range FFT at the corresponding frequency bin in a known manner, i.e., by an increased magnitude FFT value. By determining a second FFT over phases of a given range FFT bin, a Doppler FFT is obtained which indicates range rate, or velocity, in a known manner, i.e., again by an increased magnitude FFT value. A combination of range and Doppler values is referred to as a range-Doppler bin.

Detection is performed by a detection module 140 based on the range FFT 130 and on the Doppler FFT 131, resulting in identification of reflection points. Detection may for instance be performed by comparing the magnitude of FFT samples to a detection criterion, e.g., a threshold, which may be range dependent. A large magnitude value may correspond to a target at a given range and velocity as given by the range-Doppler combination. In general, herein, a reflection point is a range-Doppler value with characteristics satisfying a detection criterion. A target object detection value is a range-Doppler combination value satisfying a detection criterion. A target object reflection value is a range-Doppler combination associated with a possible target detection. These terms will be used interchangeably herein.

Optionally, a background module 141 is used in the detection. The background module comprises stored data which is a result of previous measurements or a-priori known information, and provides an estimate of an expected signal strength for each combination of range and Doppler in the absence of relevant targets. This expected signal strength is referred to herein as a background signal. A strong background signal may hide reflections from actual targets. Background signal strength is advantageously determined as an amplitude level, i.e. in terms of absolute value.

The background signal strength value from the background module 141 is according to aspects subtracted from the range FFT 130 and from the Doppler FFT 131 before detection. In this way any permanent reflections are compensated for prior to the detection, which allows for relevant targets to be detected despite presence of the background signal. For instance, the ROI often comprises stationary objects giving rise to reflections at certain fixed distances. Consequently, corresponding range-Doppler bins will always be associated with larger magnitude FFT values. By subtracting expected background signal levels prior to detecting, detection performance is improved, and false alarm rate is reduced. The main benefit of using the background module 141 is a suppression of detections of stationary objects in the ROI, facilitating detection of new relevant targets.

For each reflection point, an estimation of an angle of arrival 150 is determined. The different receiver elements 125 will be at slightly different distances from the target 116 depending on the direction from the receiver to the target. The difference in distance leads to a difference in the phase of the reflected signal as received by each antenna element 125. The angle of arrival can thus be estimated from the phase differences between receiver elements 125 for the incoming signal, provided that the relation between the phase differences and the angle of arrival is known. This angle of arrival of the reflected signal 118 can be used to determine a bearing to the target relative to a baseline of the receiving elements 125.

According to an example, the angle of arrival can be determined from the phase differences between receiver elements based on prior knowledge of the relative position of the receiver elements 125. In particular, for evenly spaced antenna elements, the phase differences as a function of angle of arrival may be determined from equations describing propagation of electromagnetic waves. Such equations are known.

According to another example, the relative phase values at the different receiving elements 125 for a given range-Doppler bin can be compared to calibration vectors from an angle calibration 151 module. The angle calibration 151 module comprises stored vectors containing previously measured or calculated phase differences between the receiver elements 125 for known angles of arrival. By comparing the relative phase values at different receiving elements 125 to the known calibration vectors, the calibration vector which best matches the incoming signal may be found. The known angle of arrival of the calibration vector then provides an estimate of the angle of arrival of the incoming signal. Interpolation between adjacent calibration vectors may be performed in order to increase angle resolution.

The background module 141, according to aspects, contains information about the relative phase difference at the different receiving elements 125 for the background signal, corresponding to the bearing of stationary objects in the ROI. This can be used to further suppress the effects of the background signal. For example, suppose a certain range-Doppler bin is associated with a high background signal level. If this range-Doppler bin then exhibits a phase vector different from that stored in the background module, a relevant target may be present, which can be inferred from the difference in received signal phase over the different antenna elements.

According to one example, suppression of background signal can be achieved by determining a matrix describing a covariance between the phase of the different receiver elements 125 in the background signal and multiplying the incoming signal 118 in the relevant range-Doppler bin by the square root of the inverse of this covariance matrix, according to known methods for whitening the noise in a signal. The main benefit is that if a range-Doppler bin contains a signal from a background object, and a relevant target at different bearings, the target can be separated from the background object using the difference in bearing.

A segment weight value is determined by a segment weight value module 160 using characteristics of the identified reflection points, i.e., the identified range-Doppler bins with associated high signal energy levels, in particular a signal to noise ratio (SNR) at least partly determines the segment weight value. SNR is generally defined as the ratio of the power of the signal to the power of any kind of noise present in the signal. However, any measure of SNR is applicable in the contexts described herein.

According to one example, the SNR of a reflection point in a range-Doppler bin may be obtained by calculating the ratio of the signal power of the reflection point to a noise estimate obtained from a range-Doppler bin where no targets are expected, e.g. a bin corresponding to a very high velocity.

According to another example, the SNR may be obtained as the ratio of the signal power of the reflection point and an estimate of the noise obtained from an average of the signal power in nearby range-Doppler bins.

According to yet another example, the SNR of a reflection point may be estimated by calculating the ratio of the signal power of the reflection point at a given range-Doppler bin and the power of the background signal in the same range-Doppler bin. In this approach, a reflection point with high signal amplitude in a range-Doppler bin where the background signal is strong will have a lower SNR than a reflection point with a similar signal amplitude in a range-Doppler bin where the background signal is weak. This has the benefit of giving an SNR value corresponding to the contribution of the target alone to the signal strength, rather than the combined contributions of target and background signal.

The determining of segment weight value corresponds to assigning a segment weight value to each of the one or more detected target object reflections. The segment weight value corresponds to a likelihood of the associated target object reflection being associated with a false alarm, this is because true object reflections, at least after compensation for background signal energy levels are often associated with higher values of SNR than false alarms.

After determining SNR and segment weight value, information has been obtained about the range, Doppler, angle of arrival, and SNR of each reflection point, i.e., range-Doppler bin that satisfy a detection criterion discussed above. This information serves as input to the filter 170, which filters the identified reflection points in such a way that the false alarm rate is reduced.

According to one example, the filter 170 comprises a threshold operation based on the segment weight value, so that reflection points with an SNR above the threshold pass through the filter, while detection points associated with lower SNR are filtered out, i.e., are removed from further processing by, e.g., the tracking algorithm.

According to another example, the filter 170 implements a comparison between the positions of reflection points across a plurality of segments 220, wherein the number L of reflection points in other segments that fall within a radius R of the reflection point is determined. Such reflection points are denoted adjacent reflection points, or adjacent reflections. A reflection point will then pass through the filter if the number L is above a threshold, and filtered out otherwise.

The radius R is pre-configured depending on operation scenario. An example value range for the radius R is between 1 and 5 meters. A preferred value of R is on the order of 1 meter. According to aspects, the radius R is configured in dependence of a range resolution and/or an angle resolution of the radar system.

According to a further example, the filter 170 combines a threshold for the segment weight value and a threshold for the number of adjacent reflection points from other segments. In particular, reflections with a segment weight value over the segment weight value threshold may pass through the filter regardless of how few adjacent reflection points are found in other segments, while reflection points with a high number of adjacent reflection points in other segments may pass through the filter regardless of segment weight value.

According to another example, the filter 170 comprises range-dependent thresholds for the segment weight value and the number of adjacent reflection points in other segments. For example, thresholds for filtering based on segment weight value and number of adjacent reflections may be lower at higher range. The main benefit of range-dependent thresholds is reducing the risk that reflection points corresponding to targets far away in range be mistaken for false alarms, considering that a given target may cause fewer reflection points with lower SNR if it is placed further away from the transceiver

The different operation examples of the filter 170 described above may be freely combined according to different aspects. In general, filter 170 performs filtering of the target object reflections over the segments based on the segment weight values.

Optionally, the tracker 180 is used to cluster the reflection points and observe them over time. This may for instance be achieved by clustering reflection points that are closer to each other than a cutoff distance, using the Doppler of the reflection points to predict the future position of the target that the reflection point cluster corresponds to, and updating the cluster with reflection points from subsequent signal frames that fall near the predicted position. According to an example, the tracker 180 comprises a Kalman filter, such as an extended Kalman filter. Kalman filters in general are known.

FIG. 1, as discussed above, illustrates a radar transceiver 100 comprising a TX module 110 arranged to transmit a radar signal 117 by at least one transmission element 115, the radar signal comprises, as shown in FIG. 2, one or more frames 210 transmitted at a duty cycle, each frame comprising N segments 220, each segment comprising M signal components 230, wherein the N segments are consecutively transmitted within the frame, the radar transceiver comprising K receiver antennas 125, K>1, arranged to receive a response signal 118 from a region of interest, ROI, the radar transceiver comprising a detection module 140 arranged to detect, for each segment, one or more target object reflections in the response signal, and a segment weight value module 160 arranged to assign, for each segment, a segment weight value to each of the one or more detected target object reflections, wherein a segment weight value corresponds to a likelihood of the associated target object reflection being associated with a false alarm, the radar transceiver also comprising a filter 170 arranged to filter the target object reflections over the N segments based on the segment weight values.

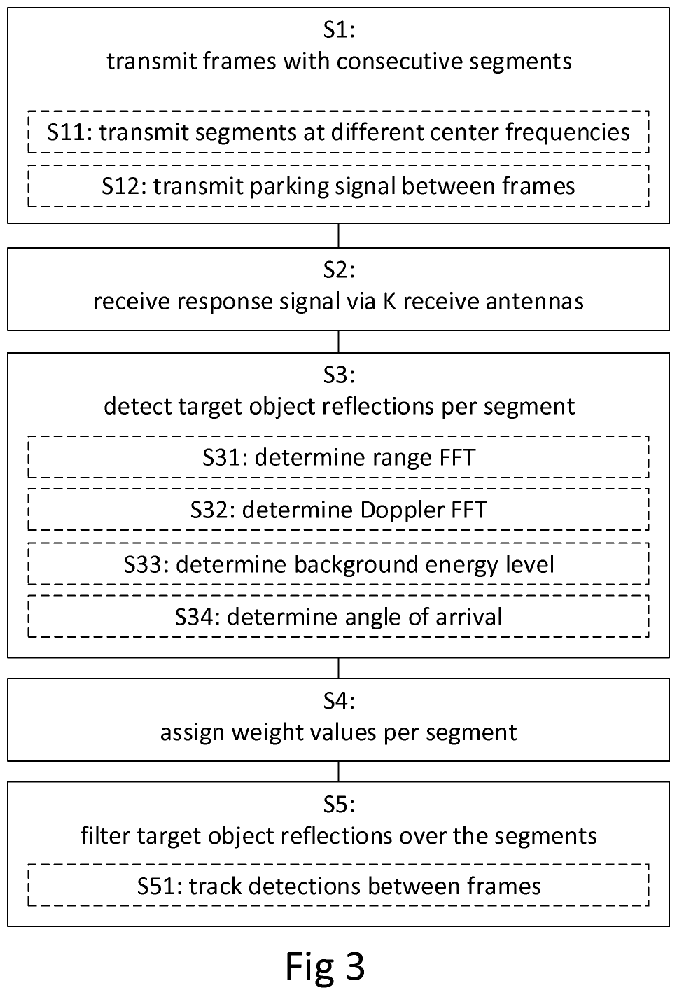

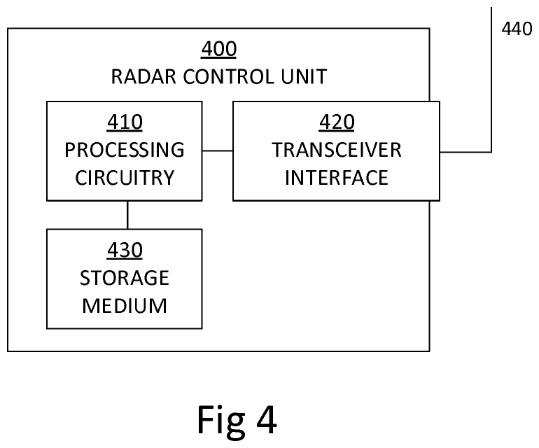

The radar transceiver, with associated components and modules, is arranged to perform operations and methods which will be discussed in more detail in connection to FIG. 3 below. An implementation example of the radar transceiver will be discussed below in connection to FIG. 4.

FIG. 3 illustrates methods for operating a radar transceiver, such as the one illustrated in FIG. 1 and FIG. 2, and discussed above, to reduce a false alarm rate. At step S1, one or more frames 210 per duty cycle are transmitted by at least one transmitter antenna 115. Each frame comprises N segments 220, each segment comprising M signal components 230. The N segments are consecutively transmitted within the frame.

According to aspects, the segments 220 are transmitted S11 at different center frequencies. A parking signal can also be transmitted S12 between frames. In addition, the signal components may be chirp signal components constituting a frequency sweep between first and second endpoint frequency values. According to an example, the frequency sweep is 500 MHz from start to finish.

According to aspects, the frame length is 25 ms, the length of the parking signal is 175 ms, N=4, M=128, and K=8.

At S2, a reflected signal 118 is received from a region of interest (ROI) by K receiver antennas 125.

At S3, for each segment, one or more target object reflections is detected in the response signal.

Optionally, S31, a range Fast Fourier Transform is determined for each of the M signal components, and S32 a Doppler Fast Fourier Transform is determined for all M signal components.

According to aspects, the FFT size of the range FFT is 512 samples and wherein the FFT size of the Doppler FFT is 128 samples.

Optionally, a measurement S33 of a background signal energy level may also be used when detecting target object reflections. The background signal measurement is performed with no relevant target in the ROI and the energy level for each combination of range and Doppler is stored. The stored energy level is subtracted from the value found in the range FFT and Doppler FFT.

The angle of arrival can be determined S34 from the relative phase differences of the K receiver elements 125.

According to aspects, the estimation of the angle of arrival may be performed by matching the phase differences between the K receiver elements 125 to angle calibration vectors comprising previously measured or calculated values for target object reflections with a known angle of arrival. Such calibration vectors were discussed above in connection to the background module 141.

According to aspects, the angle calibration may consist of a 103-by-45-point grid in azimuth and elevation. The calibration grid may cover +/−70° in azimuth and +/−30° in elevation.

According to aspects, the background signal measurement S33 may also contain information about expected angle of arrival of the background signal for each combination of range and Doppler, which can be used to distinguish an object in the background from a relevant target using their respective bearings.

In S4, for each segment and for each target object reflection, a weight value is assigned corresponding to the signal-to-noise ratio (SNR) of the target object reflection. The SNR may be determined as the ratio of the signal power in the range-Doppler bin containing the target object reflection and an estimate of the noise as discussed above.

According to aspects, the estimate of the noise may be obtained as an average of the signal power in nearby range-Doppler bins, as the signal power in a range-Doppler bin where no target is expected (e.g. corresponding to very high velocity) or from the signal power of the background signal measurement at the relevant range and Doppler.

In S5, the target object reflections are filtered over the N segments based on the segment weight values, range, Doppler, and angle of arrival, as discussed above.

According to aspects, the process of filtering may include determining whether the SNR of the target object reflection exceeds a set threshold. The threshold value may depend on other factors, such as the range of the target object reflection.

According to aspects, the process of filtering may include a comparison of the position, as given by the range and angle of arrival, between target object reflections from a plurality of segments within the same frame. The number of target object reflections from other segments within a radius R of a target object reflection may be calculated and compared to a threshold. The threshold may depend on the range of the target object reflection.

The filtering may comprise tracking S51 one or more target objects over consecutive frames.

FIG. 4 schematically illustrates, in terms of a number of functional units, the components of a radar transceiver control unit 400 according to an embodiment of the above discussions. Processing circuitry 410 is provided using any combination of one or more of a suitable central processing unit CPU, multiprocessor, microcontroller, digital signal processor DSP, etc., capable of executing software instructions stored in a computer program product, e.g. in the form of a storage medium 430. The processing circuitry 410 may further be provided as at least one application specific integrated circuit ASIC, or field programmable gate array FPGA.

Particularly, the processing circuitry 410 is configured to cause the control unit 400 to perform a set of operations, or steps. For example, the storage medium 430 may store the set of operations, and the processing circuitry 410 may be configured to retrieve the set of operations from the storage medium 430 to cause the control node 400 to perform the set of operations. The set of operations may be provided as a set of executable instructions. Thus, the processing circuitry 410 is thereby arranged to execute methods as herein disclosed.

The storage medium 430 may also comprise persistent storage, which, for example, can be any single one or combination of magnetic memory, optical memory, solid state memory or even remotely mounted memory.

The control unit 400 may further comprise a transceiver interface 420 for communications with at least one external device. As such the communication interface 420 may comprise one or more transmitters and receivers, comprising analogue and digital components and a suitable number ports for wireline or wireless communication, as well as at least one antenna 440.

The processing circuitry 410 controls the general operation of the control node 400 e.g. by sending data and control signals to the communication interface 420 and the storage medium 430, by receiving data and reports from the communication interface 420, and by retrieving data and instructions from the storage medium 430. Other components, as well as the related functionality, of the control node 400 are omitted in order not to obscure the concepts presented herein.

In other words, there is disclosed herein processing circuitry for operating a radar transceiver 100 to reduce a false alarm rate by executing methods, the methods comprise;

transmitting S1, by at least one transmitter antenna 115, one or more frames 210 at a duty cycle, each frame comprising N segments 220, each segment comprising M signal components 230, wherein the N segments are consecutively transmitted within the frame,
receiving S2, by K receiver antennas 125, K>1, a response signal 118 from a region of interest, ROI,
detecting S3, for each segment, one or more target object reflections in the response signal, assigning S4, for each segment, a segment weight value to each of the one or more detected target object reflections, wherein a segment weight value corresponds to a likelihood of the associated target object reflection being associated with a false alarm, and
filtering S5 the target object reflections over the N segments based on the segment weight values.

According to aspects, the transmitting comprises transmitting S11 the N segments at different center frequencies in a transmission frequency band.

According to aspects, the transmitting comprises transmitting S12 a parking signal 240 at a parking center frequency between transmission of the one or more frames.

According to aspects, the signal components are chirp signal components constituting a frequency sweep between first and second endpoint frequency values.

According to aspects, the detecting comprises;
determining S31 a range Fast Fourier Transform, FFT, for each of the M signal components, and
determining S32 Doppler FFTs based on the M signal components.

According to aspects, the detecting comprises determining S33 a background signal energy level prior to the detecting, and subtracting the background signal energy level from the range FFTs and from the Doppler FFTs.

According to aspects, the segment weight value is determined based on a difference measured from the target object detection value to a corresponding value of the background signal energy level.

According to aspects, the detecting comprises;

determining S34 an angle of arrival value for each range-Doppler combination, based on corresponding target object detection values from each of the K receiver antennas compared to one or more angle of arrival calibration vectors.

According to aspects, the segment weight value is determined based on a difference between one or more angle of arrival calibration vectors and corresponding target object detection values from each of the K receiver antennas.

According to aspects, the filtering comprises comparing target object reflections detected in a plurality of segments.

According to aspects, the filtering comprises calculating a difference in range and angle of arrival of target object detections from different segments.

According to aspects, the filtering is based on how many target object detections from other segments that fall within a radius R of a given target object detection.

According to aspects, the value of the radius R depends on the range of the target object detection considered.

According to aspects, the filtering comprises tracking S51 one or more target objects over consecutive frames.

According to aspects, the frame length is 25 ms, the length of the parking signal is 175 ms, N=4, M=128, and K=8.

According to aspects, the FFT size of the range FFT is 1024 samples and wherein the FFT size of the Doppler FFT is 128 samples.

1. A method for operating a radar transceiver (100) to reduce a false alarm rate, the method comprising;
transmitting (S1), by at least one transmitter antenna (115), one or more frames (210) at a duty cycle, each frame comprising N segments (220), each segment comprising M signal components (230), wherein the N segments are consecutively transmitted within the frame,
receiving (S2), by K receiver antennas (125), where K>1, a response signal (118) from a region of interest, ROI,
detecting (S3), for each segment, one or more target object reflections in the response signal, assigning (S4), for each segment, a segment weight value to each of the one or more detected target object reflections, wherein a segment weight value corresponds to a likelihood of the associated target object reflection being associated with a false alarm, and
filtering (S5) the target object reflections over the N segments based on the segment weight values.

2. The method according to claim 1, wherein the transmitting comprises transmitting (S11) the N segments at different center frequencies in a transmission frequency band.

3. The method according to claim 1, wherein the transmitting comprises transmitting (S12) a parking signal (240) at a parking center frequency between transmission of the one or more frames.

4. The method according to claim 1, wherein the detecting comprises;
determining (S31) a range Fast Fourier Transform, FFT, for each of the M signal components, and
determining (S32) Doppler FFTs based on the M signal components.

5. The method according to claim 4, wherein the detecting comprises determining (S33) a background signal energy level prior to the detecting and subtracting the background signal energy level from the range FFTs and from the Doppler FFTs.

6. The method according to claim 5, wherein the segment weight value is determined based on a difference measured from the target object detection value to a corresponding value of the background signal energy level.

7. The method according to claim 1, wherein the detecting comprises;
determining (S34) an angle of arrival value for each range-Doppler combination, based on corresponding target object detection values from each of the K receiver antennas compared to one or more angle of arrival calibration vectors.

8. The method according to claim 7, wherein the segment weight value is determined based on a difference between one or more angle of arrival calibration vectors and corresponding target object detection values from each of the K receiver antennas.

9. The method according to claim 1, wherein the filtering comprises comparing target object reflections detected in a plurality of segments.

10. The method according to claim 1, wherein the filtering comprises calculating a difference in range and angle of arrival of target object detections from different segments.

11. The method according to claim 1, wherein the filtering is based on how many target object detections from other segments that fall within a radius R of a given target object detection.

12. The method according to claim 11, wherein the value of the radius R depends on the range of the target object detection considered.

13. The method according to claim 1, wherein the filtering comprises tracking (S51) one or more target objects over consecutive frames.

14. A non-transitory computer-readable medium on which is stored a computer program for operating a radar transceiver (100) to reduce a false alarm rate, the computer program comprising computer code which, when run on processing circuitry (410) of a radar control unit (400), causes the radar transceiver (100) to execute a method according to claim 1.

15. A radar transceiver (100) comprising a TX module arranged to transmit a radar signal (117) by at least one transmission element (115), the radar signal comprising one or more frames (210) transmitted at a duty cycle, each frame comprising N segments (220), each segment comprising M signal components (230), wherein the N segments are consecutively transmitted within the frame, the radar transceiver comprising K receiver antennas (125) arranged to receive a response signal (118) from a region of interest, ROI, the radar transceiver comprising a detection module (140) arranged to detect, for each segment, one or more target object reflections in the response signal, and a segment weight value module (160) arranged to assign, for each segment, a segment weight value to each of the one or more detected target object reflections, wherein a segment weight value corresponds to a likelihood of the associated target object reflection being associated with a false alarm, the radar transceiver also comprising a filter (170) arranged to filter the target object reflections over the N segments based on the segment weight values.

16. The method according to claim 2, wherein the transmitting comprises transmitting (S12) a parking signal (240) at a parking center frequency between transmission of the one or more frames.

17. The method according to claim 2, wherein the detecting comprises;
determining (S31) a range Fast Fourier Transform, FFT, for each of the M signal components, and
determining (S32) Doppler FFTs based on the M signal components.

18. The method according to claim 3, wherein the detecting comprises;
determining (S31) a range Fast Fourier Transform, FFT, for each of the M signal components, and
determining (S32) Doppler FFTs based on the M signal components.

19. The method according to claim 2, wherein the detecting comprises;
determining (S34) an angle of arrival value for each range-Doppler combination, based on corresponding target object detection values from each of the K receiver antennas compared to one or more angle of arrival calibration vectors.

20. The method according to claim 3, wherein the detecting comprises;
determining (S34) an angle of arrival value for each range-Doppler combination, based on corresponding target object detection values from each of the K receiver antennas compared to one or more angle of arrival calibration vectors.
